(19) United States
(12) Patent Application Publication
(10) Pub. No.: US 2014/0032207 A1
(43) Pub. Date: Jan. 30, 2014

(54) Information Classification Based on Product Recognition

(71) Applicant: Alibaba Group Holding Limited, Grand Cayman (KY)

(72) Inventors: Huaxing Jin, Hangzhou (CN); Feng Lin, Hangzhou (CN); Jing Chen, Hangzhou (CN)

(73) Assignee: Alibaba Group Holding Limited, Grand Cayman (KY)

(21) Appl. No.: 13/949,970

(22) Filed: Jul. 24, 2013

(30) Foreign Application Priority Data
Jul. 30, 2012 (CN) 201210266047.3

(51) Int. Cl. G06F 17/27

(52) U.S. Cl. CPC G06F 17/2765
USPC 704/9

(57) ABSTRACT

The present disclosure provides an example information classification method and system based on product recognition. When a request for product recognition is received, one or more candidate product words of product profile information for recognition are determined. One or more characteristics of the product profile information are extracted based on the determined candidate product words respectively. Based on the candidate product words and their corresponding characteristics, the learning sub-model and the comprehensive learning model determine a product word corresponding to the product profile information. The product profile information is classified based on the product word. The present techniques implement automatic classification of the product profile information and improve an efficiency of information classification.

### CROSS REFERENCE TO RELATED PATENT APPLICATIONS

This application claims foreign priority to Chinese Patent Application No. 201210266047.3 filed on 30 Jul. 2012, entitled “Information Classification Method and System Based on Product Recognition,” which is hereby incorporated by reference in its entirety.

### TECHNICAL FIELD

The present disclosure relates to the field of communication technology, and more specifically, to an information classification method and apparatus based on product recognition.

### BACKGROUND

At an e-commerce website, product profile information published by a seller often includes various information, such as a product name, a product attribute, seller information, an advertisement, etc. It is difficult for a computing system to automatically recognize a product published by the seller and to further accurately and automatically classify the product profile information,

Under conventional techniques, the computing system often treats a title included in the product profile information published by the seller as a common sentence, and extracts a most central theme word (or a core word) from the sentence as a core of the title and whole product information. The computing system recognizes the product profile information based on the core word.

Conventional techniques rely on the title information of the product profile information to recognize the product profile information. The title often only includes about ten words and has limited information volume. Furthermore, there are various description methods used in the title. Thus, an accuracy of product recognition based on the core word of the tile is low. In addition, the core word of the title often only includes one word. Thus, it is often inaccurate to recognize the product solely based on the core word. For example, in a title “table tennis bat”, the words table and tennis have their respective specific meanings while bat has a broad meaning. It is apparent that neither of the words may accurately represent the product and accurately and automatically classify the product profile information.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides an information classification method and system based on product recognition to automatically classify product profile information and improve an efficiency of a product classification.

The present disclosure provides an example information classification method based on product recognition. A product recognition system includes one or more learning sub-models that recognize one or more products and a comprehensive learning model composed of the one or more learning sub-models. When a request for product recognition is received, one or more candidate product words of product profile information for recognition are determined. One or more characteristics of the product profile information are extracted based on the determined candidate product words respectively. Based on the candidate product words and their corresponding characteristics, the learning sub-model and the comprehensive learning model determine a product word corresponding to the product profile information and classify the product profile information based on the product word.

The present disclosure also provides an example information classification system based on product recognition. The example information classification system includes a storage module, a first determination module, a characteristic extraction module, a second determination module, and a classification module.

The storage module stores one or more learning sub-models that recognize one or more products and a comprehensive learning model composed of the one or more learning sub-models. The first determination module, when the example information classification system receives a request for product recognition, determines one or more candidate product words of product profile information for recognition. The characteristic extraction module extracts one or more characteristics of the product profile information based on the determined candidate product words respectively. The second determination module, based on the candidate product words and their corresponding characteristics, uses the learning sub-model and the comprehensive learning model to determine a product word corresponding to the product profile information. The classification module classifies the product profile information based on the product word determined by the second determination module.

Under the present techniques, when a request for product recognition is received, one or more candidate product words of product profile information for recognition are determined. One or more characteristics of the product profile information are extracted based on a respective determined candidate product word. Based on the candidate product words and their corresponding characteristics, the learning sub-model and the comprehensive learning model determine a product word corresponding to the product profile information and classify the product profile information based on the product word. Thus, the present techniques implement an automatic classification of the product profile information and improve an efficiency of information classification.

### BRIEF DESCRIPTION OF THE DRAWINGS

To better illustrate embodiments of the present disclosure, the following is a brief introduction of the FIGs to be used in the description of the embodiments. It is apparent that the following FIGs only relate to some embodiments of the present disclosure. A person of ordinary skill in the art can obtain other FIGs according to the FIGs in the present disclosure without creative efforts.

FIG. 1 illustrates a flow chart of an example information classification method based on product recognition in accordance with the present disclosure.

FIG. 2 illustrates a diagram of an example information classification system based on product recognition in accordance with the present disclosure.

### DETAILED DESCRIPTION

The present disclosure provides information classification techniques based on product recognition. Under the present techniques, a main flow process may be divided into three phases, i.e., a learning phase, a product recognition phase, and an information classification phase.

The learning phase is mainly to provide a learning model to the following product recognition phase. For example, product profile information for learning is obtained. One or more product words are extracted from the product profile information for learning. Characteristics of the product profile information are extracted based on a result of the extraction of the product words. A learning sub-model is determined based on the characteristics and the product profile information. The learning model is determined based on the learning sub-models.

The product recognition phase is mainly based on the learning model determined from the learning phase to recognize product profile information for recognition. For example, when a request for product recognition is received, a product word corresponding to the product profile information is determined based on the learning model and the product profile information included in the request for product recognition.

The information classification phase is mainly to classify the product profile information based on the determined product word. For example, the product word is matched based on one or more preset classification keyword and a classification of the product word is determined based on a result of the match.

The following descriptions are described by reference to the FIGs and some example embodiments. The example embodiments herein are solely used to illustrate the present disclosure and shall not be used to limit the present disclosure. The example embodiments or features of the example embodiments may be combined or referenced to each other when there is no conflict. It is apparent that the example embodiments described herein are only a portion of embodiments in accordance with the present disclosure instead of all of the embodiments in accordance with the present disclosure. Any other embodiments obtained by one of ordinary skill in the art without making creative efforts based on the example embodiments of the present disclosure shall still be protected by the present disclosure.

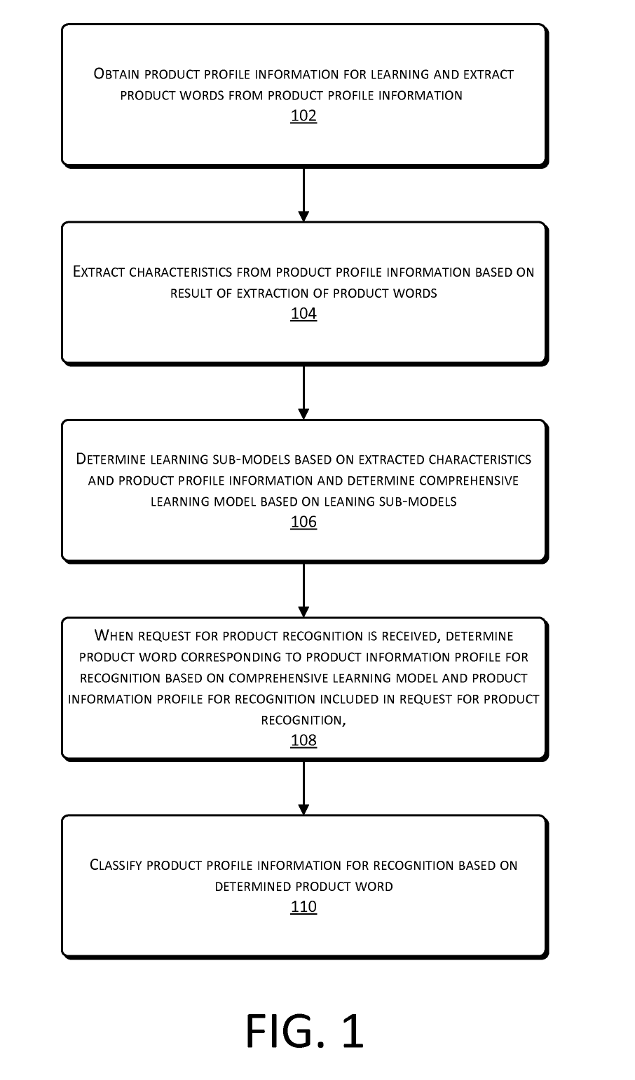

FIG. 1 illustrates a flow chart of an example information classification method based on product recognition in accordance with the present disclosure.

At 102, product profile information for learning is obtained and one or more product words are extracted from the product profile information.

For example, some product profile information may be extracted from input data of a system as learning samples (or product profile information for learning), and one or more preset rules are used to extract the product words.

For example, the operations that the preset rules are used to extract the product words may include the following. A title field of the product profile information and one or more fields from multiple fields are obtained based on the product profile information. The multiple fields include a supplied product field of a seller profile that is related with a product profile from the product profile information, an attribute filed of the product profile, a keyword field of the product profile, etc. After the fields are obtained, the fields may be processed respectively to obtain words and/or phrases included in the fields respectively. One or more words and/or phrases satisfying one or more preset conditions are determined as the product word of the product profile information.

The preset condition may include at least one of the following. A word or phrase appears in the title field of the product profile and in at least another field of the multiple fields. Alternatively, a word or phrase appears in the title field of the product profile and a total number of times of appearances of the word or phrase in all fields is no less than a threshold. The threshold may be preset, such as four.

For example, a word or phrase with a longest length from one or more words and/or phrases satisfying the preset condition may be selected as the product word of the corresponding product profile information to improve an accuracy of the determined product word.

For instance, the following words and/or phrases “MP3 Player,” “MP3,” “Player” may all satisfy the preset conditions. However, it is apparent that it is more accurate to use the phrase “MP3 Player” as the product word.

At 104, one or more characteristics of the product profile information for learning are extracted based on a result of the extraction of the product word.

For example, after the product words are extracted from the product profile information, the title field of the product profile, the supplied product field of the seller profile related with the product profile, the attribute field in the product profile, and/or the keyword field of the product profile may be obtained from the product profile information.

On one hand, words and/or phrases included in each field are obtained and a hash value of each word or phrase is obtained. A hash value of a word or phrase in the title field is used as a subject characteristic (subject_candidate_feature) of the corresponding product profile. A hash value of a word or phrase in the supplied product field is used as a supplied product characteristic (provide_products_feature) of the corresponding product profile. A hash value of a word or phrase in the attribute field is used as an attribute characteristic (attr_desc_feature) of the corresponding product profile. A hash value of a word or phrase in the keyword field is used as a keyword characteristic (keywords_feature) of the product profile.

On the other hand, based on the product profile information in which the product words are successfully extracted and their corresponding product words, a positive label characteristic (positive_label_feature) and a negative label characteristic (negative_label_feature) of the corresponding product profile are determined. For example, the following operations may be implemented.

1. provide_products_feature

The supplied product field of the seller profile related with the product profile is pre-processed. The pre-processing may include, for example, segmentation, case conversion, and/or stem extraction. A hash value is calculated for each word or phrase as a corresponding characteristic.

2. keywords_feature

The keyword field of the product profile is pre-processed. The pre-processing may include, for example, segmentation, case conversion, and/or stem extraction. A hash value is calculated for each word or phrase as a corresponding characteristic.

3. attr_desc_feature

The attribute field of the product profile is pre-processed. The pre-processing may include, for example, segmentation, case conversion, and/or stem extraction. A hash value is calculated for each word or phrase as a corresponding characteristic.

4. subject_candidate_feature

The title field of the product profile is pre-processed. The pre-processing may include, for example, segmentation, extraction of sub-strings from a chunk, case conversion, and/or stem extraction. A hash value is calculated for each word or phrase as a corresponding characteristic of a candidate word. For example, a lexical categorization may be applied to the title field, and a short phrase that is separated from another by a conjunction, a preposition, and/or punctuation in the title is referred to as the chunk.

5. positive_label_feature The following characteristics may be extracted from the product profile information.
(1) type characteristics, which may include at least one or more of the following:

The present techniques may determine whether a respective product word is all capitalized. Characters that are all capitalized usually refer to an abbreviation. If a result of the determination is positive, i.e., the product word is all capitalized, its corresponding characteristic value is 1; otherwise, its corresponding characteristic value is 0. For example, such characteristic value determination method may apply to the following type characteristics unless specified otherwise.

The present techniques may determine whether the respective product word includes a number.

The present techniques may determine whether the respective product word includes punctuation. The punctuation is used as a segmentation label when the candidate product word is generated. However, some special punctuation may not be regarded as the segmentation label, which depends on an applied word segmenting tool.

The present techniques may determine whether the word or phrase included in the respective product word shares a same lexical categorization.

The present techniques may determine a lexical category of the respective product word (or a lexical category of a majority number of words included in the respective product word). For instance, a characteristic value of a verb may be set as 10. A characteristic value of a noun may be set as 11. A characteristic value of an adjective may be set as 12. For example, such characteristic value determination method may apply to the following characteristics unless specified otherwise.
(2) universal characteristics may include at least one or more of the following:

The present techniques may determine whether a specific word included in the respective product word appears multiple times in the title.
(3) context characteristics within the chunk may include at least one or more of the following:

The present techniques may determine whether the respective product word is at a beginning of the chunk.

The present techniques may determine whether the respective product word is at an end of the chunk.

The present techniques may determine a lexical category of a word or phrase preceding the respective product word.

The present techniques may determine whether the word or phrase preceding the respective product word is all capitalized.

The present techniques may determine whether the word or phrase preceding the respective product word includes a number.

The present techniques may determine a lexical category of a word or phrase following the respective product word.

The present techniques may determine whether a word or phrase following the respective product word is all capitalized.

The present techniques may determine whether the word or phrase following the product word includes a number.
(4) context characteristics outside the chunk may include at least one or more of the following:

The present techniques may determine whether the chunk that includes the respective product word is at an end of the title.

The present techniques may determine whether the chunk that includes the respective product word is at a beginning of the title.

The present techniques may determine a lexical category of a word or phrase preceding a prior segmentation label of the chunk.

The present techniques may determine a lexical category of a word or phrase following a posterior segmentation label of the chunk.

6. negative_label_feature

Extraction of this characteristic may apply to the product profile information from which the product words are successfully extracted. A preset number (such as two) of words and/or phrases, which are different from the words and/or phrases in the respective product word from positive sample, are used as negative samples. One or more characteristics are then extracted from the negative samples. The operations are the same as or similar to extracting characteristics from the positive samples, which are not detailed herein for the purpose of brevity. For example, with respect to the product profile information, the respective product word extracted at 102 is deemed as positive samples by default. Words and/or phrases in the title that are different from the respective product word may be used as the negative samples. Using a title “4 GB MP3 Player” as an example, a product word of a positive sample (or a product word) is “MP3 Player” while the negative samples may be “MP3,” “Player,” “4 GB,” etc.

At 106, one or more learning sub-models are determined based on the extracted characteristics and the product profile information for learning and a comprehensive learning model is determined based on the learning sub-models.

For example, the one or more learning sub-models may include, but are not limited to, a priori probability model P(Y), a keyword conditional probability model P(K|Y), an attribute conditional probability model P(A|Y), a classification conditional probability model P(Ca|Y), a company conditional probability model P(Co|Y), and a title conditional probability model P(T|Y). Each of the learning sub-models is illustrated below.

After the operations of extracting characteristics are completed, the product profile information from which the product words are successfully extracted is divided into two portions. One portion of the product profile information is used as learning samples for the title conditional probability model P(T|Y). That is, P(T|Y) is determined based on such portion of the product profile information. The other portion is used as testing samples for the learning sub-models and the comprehensive learning model to test accuracies of each learning sub-model and the comprehensive learning model. For example, a number of product profile information in each portion may be similar.
(1) priori probability model P(Y)

A frequency (or a number of appearance times) of a characteristic corresponding to each word or phrase according to the characteristic provide_products_feature obtained at 104 is calculated from statistics. A frequency of a characteristic that is higher than a threshold may be taken logarithm. A normalization is further conducted to obtain the priori probability model P(Y). For example, there is no restriction to a base number when conducting the logarithm, which may be two, ten, or natural logarithm.
(2) keyword conditional probability model P(K|Y)

Characteristics subject_candidate_feature and keyword feature obtained at 104 may be used to form two vertex sets of a bipartite graph. If a word or phrase in a keyword field appears concurrently with a word or phrase in a title field in the same product profile, an edge is established between such two vertexes. A weighted value of the edge is a number of times that the two vertexes appear concurrently at the same product profile. After all product profile information, from which the product words are successfully extracted, is traversed, a weighted bipartite graph is obtained. A random walking is conducted on the weighted bipartite graph to determine the keyword conditional probability model P(K|Y).
(3) conditional probability model P(A|Y)

Characteristics subject_candidate_feature and attr_desc_feature obtained at 104 may be used to form two vertex sets of a bipartite graph. If a word or phrase in the attribute field appears concurrently with a word or phrase in the title field in the same product profile, an edge is established between such two vertexes. A weighted value of the edge is a number of times that the two vertexes appear concurrently at the same product profile. After all product profile information, from which the product words are successfully extracted, is traversed, a weighted bipartite graph is obtained. A random walking is conducted on the weighted bipartite graph to determine the keyword conditional probability model P(A|Y).
(4) classification conditional probability model P(Ca|Y)

Characteristics subject_candidate_feature obtained at 104 may be used as candidate product words and a classification distribution may be calculated from statistics of the candidate product words to determine the classification conditional probability model P(Ca|Y).
(5) company probability model P(Co|Y)

Characteristics subject_candidate_feature obtained at 104 may be used as candidate product words and a company distribution may be calculated from statistics of the candidate product words to determine the company conditional probability model P(Co|Y).
(6) title conditional probability model P(T|Y)

The title model determines a possibility of an extracted word or phrase is the product word based on the title. Such questions may be modeled as a bipartition question and a common binary classification model may be selected. The corresponding characteristics are positive_label_feature and negative_label_feature extracted at 104.

After the learning sub-models are determined, the corresponding comprehensive learning model based on the learning sub-models may be implemented by the following formula:

P(Y|O)=P(T|Y)P(K|Y)P(A|Y)P(S|Y)P(Ca|Y)P(Co|Y)P(Y)

After the comprehensive learning model is obtained, the above determined testing samples may be used to test each model and the comprehensive learning model may be used to recognize product from product profile information included in the text samples. An accuracy rate is calculated from statistics and each model may be modified or improved based on a result of the statistics.

At 108, when a request for product recognition is received, a product word corresponding to product profile information for recognition is determined based on the comprehensive learning model and the product profile information for recognition included in the request for product recognition.

For example, when the request for product recognition is received, one or more candidate product words are determined based on the product profile information for recognition included in the request for product recognition. A respective probability for a respective candidate product word is determined based on the product profile information for recognition, the respective candidate product word, and the comprehensive learning model. A candidate product word with a highest probability is determined as the product word of the product profile information for recognition. For example, the detailed implementation may be as follows.

At a first step, the candidate product words are determined. For example, lexical category recognition may be applied to a title included in the product profile information for recognition. A respective word or phrase included in one or more character strings segmented by a conjunction, a preposition, or punctuation from the title of the product profile information for recognition may be used as a respective candidate product word.

At a second step, one or more characteristics are extracted. An implementation of characteristics extraction may be the same as the implementation of characteristics extraction at the learning phase, which is not detailed herein for the purpose of brevity.

At a third step, a product is recognized. The candidate product words and their corresponding characteristics are obtained from the product profile information for recognition after the first step and the second step, and are input into one or more probability models to obtain probabilities of the candidate product words as the product word corresponding to the product profile information respectively. A candidate product word with a highest probability is used as the product word corresponding to the product profile information. In some example, the respective probabilities of the respective candidate product words as the product word corresponding to the product profile information may also be stored.

At 110, the product profile information for recognition is classified based on the product word.

For example, one or more classification keywords may be preset to classify the product profile information. When the product word of the product profile information for recognition is determined, the product word is matched according to the preset classification keywords and a classification of the product profile information for recognition is determined based on a result of the matching.

Based on the techniques as described in the example method embodiments, the present disclosure also provides an example information classification system, which may also apply the above method example embodiments.

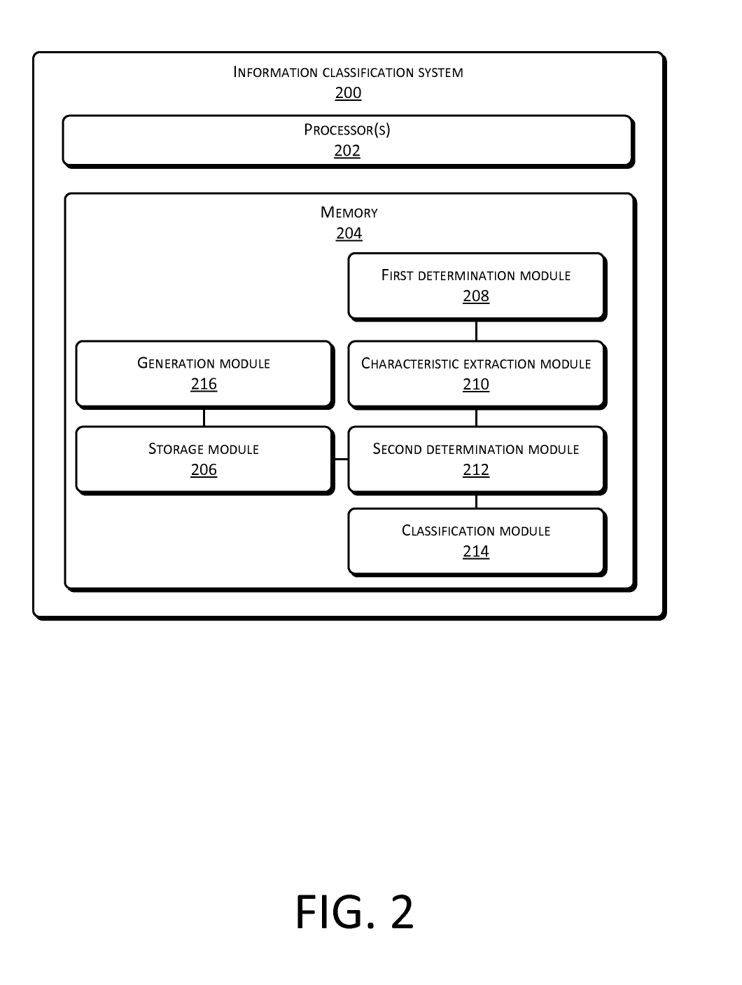

FIG. 2 illustrates a diagram of an example information classification system 200 in accordance with the present disclosure. The information classification system 200 may include one or more processor(s) 202 and memory 204. The memory 204 is an example of computer-readable media. As used herein, “computer-readable media” includes computer storage media and communication media.

Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory 204 may store therein program units or modules and program data.

In the example of FIG. 2, the memory 204 may store therein a storage module 206, a first determination module 208, a characteristic extraction module 210, a second determination module 212, and a classification module 214.

The storage module 206 stores one or more learning sub-models that recognize one or more products and a comprehensive learning model composed of the one or more learning sub-models. The first determination module 208, when the information classification system 200 receives a request for product recognition, determines one or more candidate product words of product profile information for recognition. The characteristic extraction module 210 extracts one or more characteristics from the product profile information based on a respective determined candidate product word. The second determination module 212 determines a product word corresponding to the product profile information based on the candidate product words, their corresponding characteristics, the learning sub-models, and the comprehensive learning model. The classification module 214 classifies the product profile information based on the product word determined by the second determination module 212.

For example, the first determination module 208 may also apply a lexical categorization to a title of the production profile information for recognition, and uses a respective word or phrase included in one or more character strings separated from each other by a conjunction, a preposition, and/or punctuation as the respective candidate product word.

For example, the characteristic extraction module 210 may obtain a title field of a product profile, a supplied product field of a seller profile that is related with the product profile, an attribute filed of the product profile, and a keyword field of the product profile according to the product profile information for recognition. The characteristic extraction module 210 may also extract words and/or phrases included in each field and determine a hash value of each word or phrase. For instance, the characteristic extraction module 210 may use a hash value of a word or phrase in the title field as a subject characteristic of the corresponding product profile, use a hash value of a word or phrase in the supplied product field as a supplied product characteristic of the corresponding product profile, use a hash value of a word or phrase in the attribute field as an attribute characteristic of the corresponding product profile, and use a hash value of a word or phrase in the keyword field as a keyword characteristic of the product profile.

For example, the characteristic extraction module 210 may also determine a positive label characteristic and a negative label characteristic of the product profile information for recognition based on each candidate product word.

For example, the second determination module 212 may determine a respective probability for a respective candidate product word based on the respective candidate product word and its corresponding characteristics by using the learning sub-models, and the comprehensive learning model, and determine a candidate product word with a highest probability as the product word of the product profile information for recognition.

For example, the classification module 214 may match the determined product word based on one or more preset classification keywords, and determine a classification of the product profile information for recognition based on a result of the matching.

For another example, the product recognition system 200 may also include a generation module 216. The generation module 216 generates the learning sub-models and the comprehensive learning model for product recognition. For instance, the generation module 216 may obtain product profile information for learning and extract one or more product words from the product profile information for learning, extract characteristics from the product profile information for learning based on a result of a result of the extraction of the product words, determine the learning sub-models based on the characteristics and the product profile information for learning, and determine the comprehensive learning model based on the learning sub-models.

For example, the generation module 216 may extract the product words from the product profile information for learning by using the following methods. The generation module 216 extracts a title field of the product profile information for learning and one or more fields from the following fields are obtained based on the product profile information for learning. The following fields include a supplied product field of a seller profile that is related with a product profile from the product profile information, an attribute field of the product profile, a keyword field of the product profile, etc. The generation module 216 determines one or more words and/or phrases satisfying the preset conditions as the product word of the product profile information for learning.

The preset conditions may include at least one of the following. A word or phrase appears in the title field of the product profile and at least another of the above fields. Alternatively, a word or phrase appears in the title field of the product profile and a total number of times of appearances of the word or phrase in all fields is no less than a threshold.

For another example, the generation module 216 may also extract characteristics from the product profile information for learning based on the product words by the following methods. The generation module 216 obtains a title field of a product profile, a supplied product field of a seller profile that is related with the product profile, an attribute field of the product profile, and a keyword field of the product profile according to the product profile information for learning. The generation module 216 may also extract words and/or phrases included in each field and determine a hash value of each word or phrase.

For instance, the generation module 216 may use a hash value of a word or phrase in the title field as a subject characteristic of the corresponding product profile, use a hash value of a word or phrase in the supplied product field as a supplied product characteristic of the corresponding product profile, use a hash value of a word or phrase in the attribute field as an attribute characteristic of the corresponding product profile, and use a hash value of a word or phrase in the keyword field as a keyword characteristic of the product profile.

For example, the generation module 216 may also determined a positive label characteristic and a negative label characteristic of the product profile information for learning based on each candidate product word.

One of ordinary skill in the art would understand that the modules in the example apparatus may locate at an apparatus as described in the present disclosure, or have corresponding changes and locate at one or more apparatuses different from those described in the present disclosure. The modules in the example embodiment may be integrated into one module or further segmented into multiple sub-modules.

One of ordinary skill in the art would understand that the embodiments of the present disclosure may be implemented hardware, software, or a combination of software and necessary hardware. In addition, the implementation of the present techniques may be in a form of one or more computer software products containing the computer-executed codes or instructions which can be included or stored in the computer storage media (including but not limited to disks, CD-ROM, optical disks, etc.) and cause a device (such as a cell phone, a personal computer, a server, or a network device) to perform the methods according to the present disclosure.

The above descriptions illustrate example embodiments of the present disclosure. The embodiments are merely for illustrating the example embodiments and are not intended to limit the scope of the present disclosure. It should be understood by one of ordinary skill in the art that certain modifications, replacements, and improvements can be made and should still be considered under the protection of the present disclosure without departing from the principles of the present disclosure.

What is claimed is:

1. A method comprising:
receiving a request for product recognition, the request for product recognition including product profile information for recognition;
determining one or more candidate product words of the product profile information for recognition;
extracting one or more respective characteristics from the product profile information for recognition according to the determined one or more candidate product words respectively;
determining a product word corresponding to the product profile information for recognition at least based on the determined one or more candidate product words and their corresponding respective characteristics; and
classifying the product profile information for recognition according to the determined product word.

2. The method as recited in claim 1, wherein the determining the one or more candidate product words comprises:
applying a lexical categorization to a title of the product profile information for recognition; and
using a word or phrase included in one or more character strings segmented by a conjunction, a preposition, or a punctuation as a respective candidate product word.

3. The method as recited in claim 1, wherein the extracting the one or more respective characteristics from the product profile information for recognition according to the determined one or more candidate product words respectively comprises:
obtaining a title field of the product profile information for recognition;
determining a hash value of a word or phrase included in the title field; and
using the hash value of the word or phrase included in the title field as a title characteristic of the product profile information for recognition.

4. The method as recited in claim 1, wherein the extracting the one or more respective characteristics from the product profile information for recognition according to the determined one or more candidate product words respectively comprises:
obtaining a supplied product field of a seller profile related to the product profile information for recognition;
determining a hash value of a word or phrase included in the supplied product field; and
using the hash value of the word or phrase included in the supplied product field as a supplied product characteristic of the product profile information for recognition.

5. The method as recited in claim 1, wherein the extracting the one or more respective characteristics from the product profile information for recognition according to the determined one or more candidate product words respectively comprises:
obtaining an attribute field of the product profile information for recognition;
determining a hash value of a word or phrase included in the attribute field; and
using the hash value of the word or phrase included in the attribute field as an attribute characteristic of the product profile information for recognition.

6. The method as recited in claim 1, wherein the extracting the one or more respective characteristics from the product profile information for recognition according to the determined one or more candidate product words respectively comprises:
obtaining a keyword field of the product profile information for recognition;
determining a hash value of a word or phrase included in the keyword field; and
using the hash value of the word or phrase included in the keyword field as a keyword characteristic of the product profile information for recognition.

7. The method as recited in claim 1, wherein the extracting the one or more respective characteristics from the product profile information for recognition according to the determined one or more candidate product words respectively comprises:
determining a positive label characteristic of the product profile information for recognition based on the one or more candidate product words respectively.

8. The method as recited in claim 1, wherein the extracting the one or more respective characteristics from the product profile information for recognition according to the determined one or more candidate product words respectively comprises:
determining a negative label characteristic of the product profile information for recognition based on the one or more candidate product words respectively.

9. The method as recited in claim 1, further comprising generating one or more learning sub-models and a comprehensive learning model based on the one or more learning sub-models for product recognition.

10. The method as recited in claim 9, wherein the generating comprises:
obtaining product profile information for learning;
extracting one or more product words from the product profile information for learning;
extracting one or more characteristics from the product profile information for learning based on a result of the extracted one or more product words;
determining the one or more learning sub-models based on the characteristics and the product profile information for learning; and
determining the comprehensive learning model based on the one or more learning sub-models.

11. The method as recited in claim 10, wherein the extracting one or more product words from the product profile information for learning comprises:
obtaining a title field and at least one of multiple fields from the product profile information for learning, the multiple fields including a supplied product field of a seller profile related to a product profile, an attribute field of the product profile, and a keyword field of the product profile; and
determining a word or phrase satisfying at least one of preset conditions as the product word corresponding to the product profile information.

12. The method as recited in claim 11, wherein the preset conditions include:
the word or phrase appears in the title field of the product profile and at least one field of the multiple fields; and
the word or phrase appears in the title field of the product profile and a number of times that the word or phrase appears in the multiple fields is higher than a threshold.

13. The method as recited in claim 1, wherein the determining the product word corresponding to the product profile information for recognition at least based on the determined one or more candidate product words and their corresponding respective characteristics comprises:
determining a respective probability of a respective candidate product word as the product word at least based on the respective candidate product word and one or more characteristics corresponding to the respective candidate product word;
selecting a candidate product word with a highest probability as the product word corresponding to the product profile information for recognition.

14. The method as recited in claim 1, wherein the classifying the product profile information for recognition according to the determined product word comprises:
matching the product word based on one or more preset classification keywords; and
determining a classification of the product profile information for product recognition based on a result of the matching.

15. A method comprising:
obtaining product profile information for learning;
extracting one or more product words from the product profile information for learning;
extracting one or more characteristics from the product profile information for learning based on a result of the extracted one or more product words;
determining one or more learning sub-models based on the extracted characteristics and the product profile information for learning; and
determining the comprehensive learning model based on the one or more learning sub-models.

16. The method as recited in claim 15, further comprising:
receiving a request for product recognition, the request for product recognition including product profile information for recognition;
determining a product word corresponding to the product profile information for recognition based on the comprehensive learning model and the product profile information for recognition.

17. The method as recited in claim 16, further comprising classifying the product profile information for recognition based on the determined product word.

18. A system comprising:
a storage module that stores one or more learning sub-models and a comprehensive learning model based on the one or more learning sub-models for product recognition;
a first determination module that, when the system receives a request for product recognition, determines one or more candidate product words of product profile information for recognition;
a characteristic extraction module that extracts one or more characteristics from the product profile information for recognition based on the determined candidate product word respectively;
a second determination module that determines a product word corresponding to the product profile information based on the candidate product words, their corresponding characteristics by using the learning sub-models and the comprehensive learning model; and
a classification module that classifies the product profile information for product recognition based on the determined product word.

19. The system as recited in claim 18, further comprising a generation module that generates the one or more learning sub-models and the comprehensive learning module.

20. The system as recited in claim 19, wherein the generation module further:
obtains a title field and at least one of multiple fields from the product profile information for learning, the multiple fields including a supplied product field of a seller profile related to a product profile, an attribute field of the product profile, and a keyword field of the product profile; and
determines a word or phrase satisfying at least one of preset conditions as the product word corresponding to the product profile information,
wherein the preset conditions include:
the word or phrase appears in the title field of the product profile and at least one field of the multiple fields; and
the word or phrase appears in the title field of the product profile and a number of times that the word or phrase appears in the multiple fields is higher than a threshold.
